(19) United States
(12) Patent Application Publication
(10) Pub. No.: US 2010/0039971 A1
(43) Pub. Date: Feb. 18, 2010

(54) Power Management Method and Communication System

(75) Inventors: Kar-Wing Edward Lor, Hong Kong (CN); Yun Kau Lee, Hong Kong (CN)

Correspondence Address: WELLS ST. JOHN P.S., 601 W. FIRST AVENUE, SUITE 1300, SPOKANE, WA, 99201, US

(73) Assignee: Hong Kong Applied Science and Technology Research Institute, Co.

(21) Appl. No.: 12/192,736

(22) Filed: Aug. 15, 2008

(51) Int. Cl. H04W 52/02

(52) U.S. Cl. 370/311

(57) ABSTRACT

Keep-alive transactions between a device and a wireless network service are handled by the network interface of the device without precipitation of the device processor. The device processor may be placed in a power save mode and the connection between the device and the wireless network service maintained without waking the device processor to handle keep-alive transactions.

### BACKGROUND

1. Field of the Invention

The current invention relates to a power management method, in particular to a power management method for a mobile device, and to a communication system.

2. Background Information

Power consumption and battery life are still major challenges for the designers of mobile electronic equipment. To keep with the demands of technology savvy consumers, mobile device makers are coming up with smaller more feature packed devices. With the proliferation of WiFi access points in both private and public areas WiFi radio has become an almost essential element in the modern mobile device. Consumers are able to stay connected to the myriad of internet based and wireless services available for mobile devices. Often the services require the consumer to stay connected to a wireless network and logged in to an internet based service provider for extended periods although for a large portion of the time the mobile device will be inactive on the network, wireless hotspot or internet based service. Despite extended period of an activity the mobile device is required to process certain keep-alive transaction in order to maintain its connected or logged in state. An example of such a situation is a WiFi or VoIP phone. The phone should stay connected to a wireless network and logged in to a VoIP telephony service even when not otherwise in us so that it can receive calls.

The traditional approach for reducing power consumption and conserving battery power during idol periods is to allow the device, principally the device processor, to go into a standby or sleep mode. However, if the device is to maintain a connection with a wireless network and optionally a network service the device processor must wake up periodically to process keep-alive transactions. There are two types of keep-alive transaction, namely pro-active and reactive keep-alives. In pro-active keep-alives the device processor wakes up at pre-scheduled times, process the keep-alive transaction, typically by sending keep-alive packets, and then goes back to sleep. In a reactive keep-alive the network or WiFi access service sends a message to check the device's presence. When the message is received the device processor wakes up to process the message and send a reply. The time period between keep-alive transactions can vary from a few hundred milliseconds to several minutes or even hours. The frequency of keep-alive transactions at different layers of the OSI reference model is illustrated in the table 1.

TABLE 1

| Layer | Actions | Keep-Alive Logistics | Frequencies |
|---|---|---|---|
| MAC | Notify the AP of the | AP dependent | From hundreds of ms to |
| (802.11) | device presence | | minutes |
| MAC | Response to ARP requests | Hotspot dependent | From seconds to minutes |
| IP | Dynamic address renewal | Server dependent; expiry | From a few minutes to |
| | | time encapsulated in | days |
| | | server response | |
| IP | Response to PING | Hotspot dependent | From seconds to minutes |
| | requests | | |
| TCP/UDP | NAT traversal keep-alive | Expiry time is NAT | IETF good practice |
| | | implementation dependent | recommendation: once |
| | | | every 15 sec |
| Session | WiFi hotspot service keep- | Hotspot dependent | Can be seconds, minutes |
| | alive | | or not needed |
| Application | SIP server registration | Service dependent; expiry | From minutes to hours |
| | renewal | time encapsulated in | |
| | | server response | |

It can be seen that keep-alive transactions are required at many different layers in order to maintain network and service connectivity. This failure of a keep-alive transaction at any one particular layer could result in the device disconnecting from the network or host service to which the user had subscribed. For example, at the physical/data layer the device must notify the wireless access point of its presence and respond to ARP requests which can have a frequency in the range of a few hundred milliseconds to a few minutes. At the network layer the device must renew its network address and respond to PING requests. These activities could have a frequency ranging from second, minutes to days. At the transport and session layers the device might possibly have to process keep-alive transactions periodically and at that the application layer the device has to periodically renew its server registration.

The number of keep-alive transactions that need to be processed by a device wishing to maintain a logged in state to a remote server, for example in the case of a wireless VoIP phone, poses a major challenge to power consumption and battery life.

### SUMMARY OF THE INVENTION

It is an object of the present invention to provide a power management method and/or communication system for a device maintaining a connection state with a network that reduces the power requirements for processing keep-alive transactions, or which at least ameliorates some of the power consumption concerns associated with maintaining a wireless connection in prior art devices, or which offers the art with a useful alternative.

The device network interface or adapter must wake up to handle the sending and receiving of the keep-alive transition messages. The invention provides a method of processing frequent network keep-alive transactions in which the keep-alive transactions are processed in the network interface or adapter of the device so that the device, and in particular the device processor, can maintain a sleep-mode without waking up to process the keep-alive transitions.

In a particular aspect of the invention there is provided a power management method for a mobile wireless device having an device processor having a sleep mode and a radio module for connecting the device with a wireless network, the method comprising during connection of the device with to a wireless network placing the device processor in the sleep mode and while the processor is in the sleep mode processing keep-alive transactions in the radio module. The processing of keep-alive transactions requests in the radio module can be by either hardware of the radio module or in software using an embedded processor of the radio module, and preferably comprises using a packet filtering of packets received by the radio module. In packet filtering a received packet is checked within the radio module and if the packet matches established criteria of a keep-alive packet then it is not passed to the device processor and a keep-alive packet is sent from the radio module without waking the device processor. The radio module also sends a keep-alive packet at an established interval without waking the device processor.

In another aspect of the invention there is provided a radio for a mobile wireless device having a device processor, the radio comprising a transmitter and receiver, an embedded processor for processing of data received or to be sent, and a keep-alive module for processing keep-alive transactions in the radio when the device processor is in a sleep mode. The keep-alive module can be either hardware of software and preferably comprises a packet filter for filtering packets received by the radio.

In yet a further aspect of the invention there is provided a communication system for maintaining a connection state between a device having a device processor and network. The communication system comprises a device communication interface for providing the device with means to communicate with the network. Frequent network keep-alive transactions between the device and the host are handled in the device communication interface without participation of the device processor so that the device processor can be placed on a sleep mode and need not be woken up to handle keep-alive transactions. The device communication interface has a keep-alive module that can be either hardware of software and preferably comprises a packet filter for filtering packets received by the radio. The keep-alive module is programmed or adapted to respond to a keep-alive transaction initiated by the host and to initiate a keep-alive transaction at an established interval.

Further aspects of the invention will become apparent from the drawings and description which are given by way of example only to illustrate the invention.

### BRIEF DESCRIPTION OF THE DRAWINGS

Preferred embodiments of the invention will now be described with reference to the attached drawings in which:

FIG. 1 is a schematic illustration of wireless chipset architecture according to a first preferred embodiment of the invention,

FIG. 2 is a schematic illustration of wireless chipset architecture according to a second preferred embodiment of the invention,

FIG. 3 is a process flow diagram of a preferred method of the invention, and

FIG. 4 is a schematic illustration of an ARP request packet and an ARP reply packet.

### DESCRIPTION OF THE PREFERRED EMBODIMENTS

The invention will now be described with reference to one or more exemplary embodiments. The invention will be illustrating as practiced in a mobile WiFi VoIP phone that should preferably maintain a wireless, WiFi, connection and registration with a VoIP service provider server. However, this is not intended to limit the scope of use or functionality of the invention. The skilled addressee will appreciate that the invention may be practiced in other types of mobile wireless device where power consumption and battery life are important considerations. Further, the invention is not limited to use in mobile or battery operated equipment or in wirelessly connected equipment. Environmental concerns and rising energy costs have made energy efficiency an important design criterion in all types of electronic equipment whether mains powered or wired to a network. The invention may also find application in a mains-powered and/or wired device. The invention is directed at power management and in particular to reducing power consumption particularity when a device must remain connected to a network or host. However, the invention may also be used to reduce network connection management overhead from a device application processor which in turn may speed up processing time of other tasks or allow lower power processors to be used.

Where used in the document the term sleep mode refers to a power saving mode where a device or processor of a device reduces or shuts down some or all of its functions or activity in order to reduce energy consumption. The term sleep mode is interchangeable with similar terms such a standby, suspend, hibernate and the like. The terms waken, wake, wake up and the like refer to the device or processor coming fully or partially out of a power saving mode in order to respond to some input or perform some scheduled activity. Keep-alive or keep-alive transaction refers to signals often sent between two or more connected devices or services at established or predetermined intervals to determine that a device is still present, that the connection between the devices is not down or to perform connection housekeeping functions.

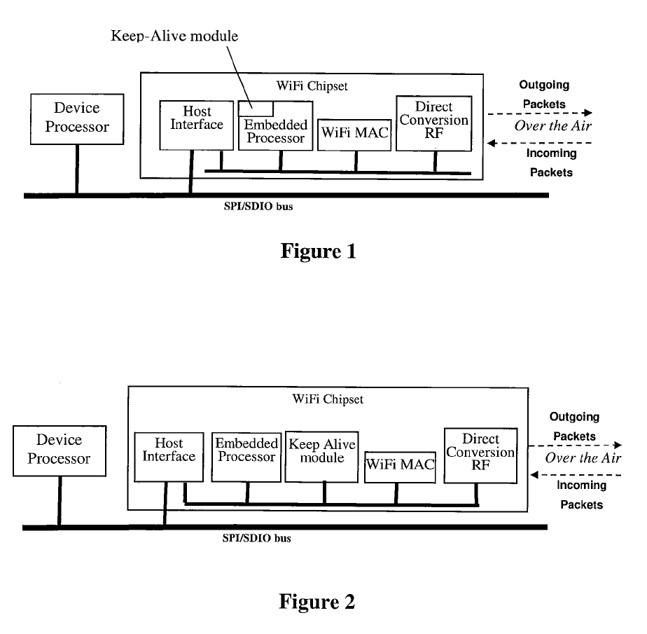

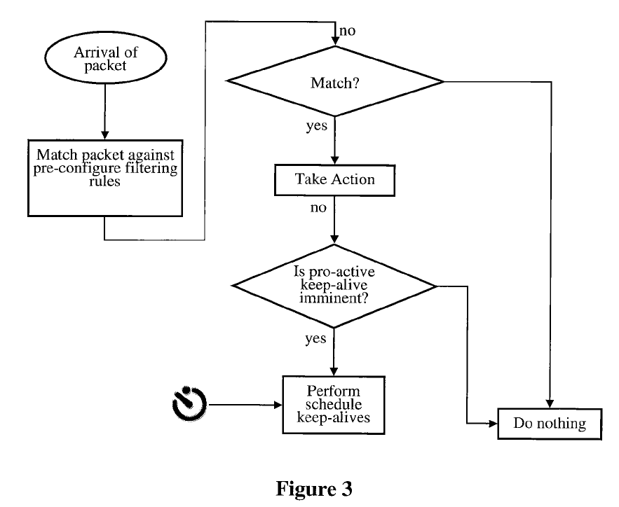

In FIGS. 1 and 2 there are depicted a preferred embodiments of a wireless network adapter according to the invention. The adaptor is incorporated into a wireless device having and application processor and allows the device and processor to communicate over a wireless network. In the preferred embodiments the wireless network adapter is based on the IEEE 802.11 or WiFi standard. However this is not essential to the invention and the wireless network adapter may use other standards such as Ultra-wideband, Bluetooth, ZigBee, and Wireless USB. The adaptor comprises a RF transmitter receive, a Media Access Control (MAC) module, an embedded processor and a host interface as is known in the art. The adaptor of the invention also comprises a keep-alive processing module for handling keep-alive transactions within the network adapter. In the preferred embodiment of FIG. 1 the keep-alive processing module is a software module resident in the adaptor embedded processor. Because keep-alive transactions primarily or almost exclusively occur during idle connection periods the embedded processor of the network adaptor has sufficient resources to handle the keep-alive transactions without increasing its processing power. In an alternative embodiment of FIG. 2 the keep-alive processing module is a separate hardware module incorporated into the network adapter as additional circuitry or an ASIC. The inventors prefer the software module resident in the adaptor embedded processor because it does not require significant, if any, hardware redesign or modification of existing wireless network adapter hardware architecture. The software module can be simply implemented through firmware changes or updates to the wireless network adaptor.

The power management method of the invention is this. A mobile WiFi VoIP phone, for example, is provided with a wireless network adapter having a keep-alive processing module. When the phone is turned on or activated the phone processor connects to an available wireless network and logs in to a VoIP server such as a SIP server. The phone is now ready to make or receive VoIP telephone calls. After a period of inactivity the phone processor goes into a sleep mode in order to save power. During sleep mode the phone should maintain its wireless connection and keep open a pinhole, or port, through any firewall. To do so it must respond to Address Resolution Protocol (ARP) requests and/or Wi-Fi service PINGs, and handle network address translation (NAT) traversal keep-alives up to 7 times a minute. These keep-alive transactions are handled by the keep-alive processing module of the wireless adaptor so that the device processor does not need to wake up from its sleep mode. The device processor does not participate in the frequent keep-alive transactions. The wireless adaptor is required to wake up in any case for the processing of keep-alive transactions because it has to receive or transmit the keep-alive packets anyway.

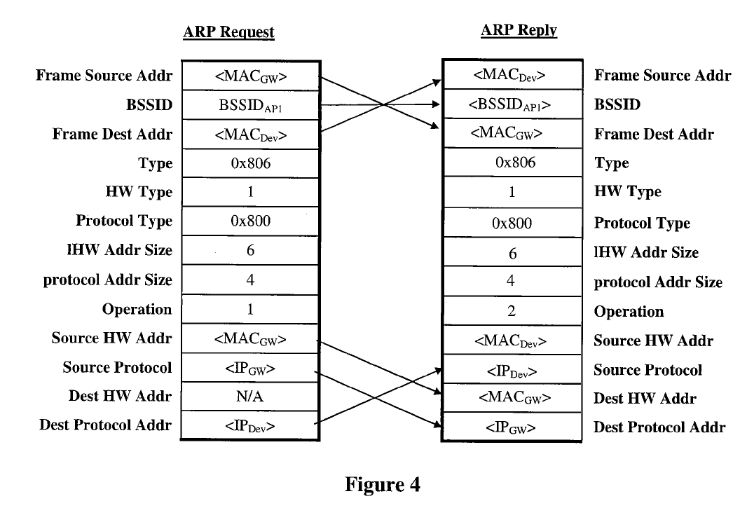

The processing of these frequent keep-alive transactions within the wireless network adaptor is within the capability and knowhow of one skilled in the art. FIG. 3 illustrates a preferred method of processing of keep-alive transactions within the wireless network adaptor using a packet filtering approach. Packet filtering methods are well known in network routing and firewall applications. A packet filter implemented in the keep-alive processing module compares incoming packets with established criteria in order to identify keep-alive transaction packets. If a packet does not patch the established criteria then it is passed to the application processor which must wake up and process the packet. However, if the incoming packet matches the established criteria of a certain type of keep-alive transaction the packet does not get forwarded to the application processor. Instead the keep-alive processing module of the network adaptor generates the response packet which is sent to the originator of the incoming keep-alive probe. FIG. 4 illustrates and example of a reactive keep-alive transaction in which an ARP probe packet is received, the packet is filtered and copied to the keep-alive processing module which maps the fields to an ARP reply packet. At the same time the keep-alive processing module periodically generates and sends proactive keep-alive packets at establish time intervals in accordance with AP or network. In this way frequent APP and certain network keep-alive transactions are handled within the wireless network adaptor without waking the phone application processor.

In the preferred embodiment the keep-alive module of the network adaptor only handles the very frequent ARP requests or PINGs from the WiFi access service and NAT traversal keep-alives which require very little processing power to handle and which occur very frequently, for example up to 3 or 4 times each per second. These keep-alive transactions, if handled by a device processor would require the device processor to wake-up many times per minute which defeats the purpose of the sleep mode. It is envisage that other keep-alive transactions with the WiFi access service and/or the application service, for example the VoIP service, which are more complicated, which require more processing power and/or special applications to be loaded to the device processor, and which occur much less frequently, for example only every several minutes or a few times an hour, are still handled by the device processor. Waking up the device processor only every few minutes or several times an hour to process keep-alive transactions is less detrimental to the power saving of sleep mode.

The following illustrates the power saving of the invention. The following calculations and assumptions are based on a Wi-Fi phone under test which uses a Freescale CodeFire device processor and a Marvell 8686 Wi-Fi module.
An application processor consumes 3.2 mA in power save mode and 80 mA awake.
Keep-alive processing takes 150 ms.
NAT keep-alive requirement is once 15 seconds.
WiFi hotspot keep-alive requirement is 3 ARPs per minute.
Best case keep-alives per minute is 4 (NAT and APRs overlap), worse case is 7 (no overlap).
A Wireless network adaptor consumes 150 mA awake and takes 200 ms to process each keep-alive.
The Wireless network adaptor must wake up to receive and/or transmit keep alive packets anyway and the extra power required to process keep alive transactions is negligible.

The following table give power consumption for best and worse case keep-alives processed by application processor or wireless network adaptor.

| | Best Case | | | | Worse Case | | | |
|---|---|---|---|---|---|---|---|---|
| | Prior art | | Invention | | Prior art | | Invention | |
| Application | 3 × 80 × .15 × 4 = 144 | mW | = 0 | mW | 3 × 80 × .15 × 7 = 252 | mW | = 0 | mW |
| processor | | | | | | | | |
| awake | | | | | | | | |
| Application | 3 × 3.2 × 59.4 = 570 | mW | 3 × 3.2 × 60 = 576 | mW | 3 × 3.2 × 58.95 = 566 | mW | 3 × 3.2 × 60 = 576 | mW |
| processor | | | | | | | | |
| asleep | | | | | | | | |
| Wireless | 1.8 × 150 × .2 × 4 = 216 | mW | 1.8 × 150 × .2 × 4 = 216 | mW | 1.8 × 150 × .2 × 7 = 378 | mW | 1.8 × 150 × .2 × 7 = 378 | mW |
| adaptor | | | | | | | | |
| awake | | | | | | | | |
| Total | 930 | mW | 792 | mW | 1196 | mW | 954 | mW |

In the best case the power saving by the invention is 20% and the worse case power saving is 15%.

The preferred embodiments of the invention have been described, however these are not intended to limit the use or functionality of the invention. It should be appreciated that modifications and/or alterations obvious to those skilled in the art are not considered as beyond the scope of the invention. For example, the preferred embodiment describes a wireless network adaptor, however the keep-alive processing module may be included in a wired network adaptor such as an Ethernet card. The invention can equally be practiced in a desktop computer for example where the computer CPU can enter a sleep or standby mode while the network interface card processes keep alive transaction with network resources or remote hosts in order to maintain connectivity during the idle period.

What is claimed is:

1. A power management method for a mobile wireless device having an device processor with a power save mode and a radio module for accessing a wireless network, the method comprising when accessing a wireless network placing the device processor in the power save mode and while the processor is in the power save mode processing network access keep-alive transactions in the radio module.

2. The method of claim 1 wherein the network access keep-alive transactions comprises one or more of transaction for maintaining access to a wireless network and/or keeping open a port in a firewall.

3. The method of claim 1 wherein processing keep-alive transactions requests in the radio module comprises processing in hardware of the radio module.

4. The method of claim 1 wherein processing keep-alive transactions requests in the radio module comprises processing in software using an embedded processor of the radio module.

5. The method of claim 1 wherein processing keep-alive transactions requests in the radio module comprises packet filtering of packets received by the radio module.

6. The method of claim 4 wherein packet filtering comprises checking packets within the radio module and if the packet matches established criteria then not passing the packet to the device processor and sending a keep-alive packet from the radio module without waking the device processor.

7. The method of claim 1 wherein processing keep-alive transactions requests in the radio module comprises sending a keep-alive packet from the radio module at an established interval without waking the device processor.

8. A radio for a mobile wireless device having a device processor, the radio comprising:
a transmitter and receiver,
an embedded processor for processing of data received or to be sent, and
a keep-alive module for processing keep-alive transactions in the radio when the device processor is in a power save mode.

9. The radio of claim 7 wherein the keep-alive module is a hardware module.

10. The radio of claim 7 wherein the keep-alive module is a software module.

11. The radio of claim 7 wherein the keep-alive module comprises a packet filter for filtering packets received by the radio.

12. A communication system for maintaining a connection state between a device having a device processor and a wireless access service, the communication system comprising a device communication interface for providing a device with means to communicate with a wireless access service, wherein keep-alive transactions between the device and the wireless access service are handled in the device communication interface without participation of the device processor.

13. The communication system of claim 11 wherein the device communication interface comprises a keep-alive module for processing the keep-alive transactions between the device and the host, the keep-alive module adapted to responding to a first keep-alive transaction initiated by the host and to initiate a second keep-alive transaction at an established interval.

14. The communication system of claim 12 wherein responding to a first keep-alive transaction initiated by the host comprises packet filtering of packets received by the device communication interface.

15. The communication system of claim 11 wherein the keep-alive module comprises hardware for processing the keep-alive transactions.

16. The communication system of claim 11 wherein the keep-alive module comprises software for processing the keep-alive transactions in an embedded processor of device communication interface.

17. A power management method for a device having an device processor with a power save mode and a network adapter for accessing a network, the method comprising when accessing a network placing the device processor in the power save mode and while the processor is in the power save mode processing network access keep-alive transactions in the network adapter.
